(19) United States
(12) Patent Application Publication
(10) Pub. No.: US 2026/0296183 A1
(43) Pub. Date: Oct. 1, 2026

(54) CONTROL APPARATUS FOR FOUR-WHEEL DRIVE VEHICLE

(71) Applicant: TOYOTA JIDOSHA KABUSHIKI KAISHA, Toyota-shi (JP)

(72) Inventors: Yoshio ITOU, Susono-shi (JP); Yu INASE, Susono-shi (JP); Taichi KOBAYASHI, Susono-shi (JP); Hironori KUMAZAKI, Susono-shi (JP)

(73) Assignee: TOYOTA JIDOSHA KABUSHIKI KAISHA, Toyota-shi (JP)

(21) Appl. No.: 19/629,476

(22) Filed: Mar. 26, 2026

(30) Foreign Application Priority Data
Mar. 27, 2025 (JP) 2025-054490

(51) Int. Cl. B60K 17/34; B60K 1/00; B60K 17/22

(52) U.S. Cl. CPC B60K 17/34; B60K 1/00; B60K 17/22

(57) ABSTRACT

A power transmission device for a four-wheel drive vehicle includes: a power distribution mechanism configured to distribute a power transmitted from an input shaft, between a first output shaft and a second output shaft; and a transmission mechanism which is provided in a power transmission path between the power distribution mechanism and the second output shaft such that the power is to be transmitted through a power transmission position between the power distribution mechanism and the transmission mechanism. The transmission mechanism is disposed on an axis parallel to axes of the input shaft, the first output shaft and the second output shaft, such that the transmission mechanism extends from the power transmission position toward a front side of the vehicle in a longitudinal direction of the vehicle.

This application claims priority from Japanese Patent Application No. 2025-054490 filed on Mach 27, 2025, the disclosure of which is herein incorporated by reference in its entirety.

### FIELD OF THE INVENTION

The present invention relates to a power transmission device for a four-wheel drive vehicle in which a torque of a power source is to be distributed and transmitted to front wheels and rear wheels.

### BACKGROUND OF THE INVENTION

There is well-known a power transmission device for a four-wheel drive vehicle based on front-engine rear-wheel drive (FR) in which a torque of a power source is to be distributed and transmitted to front wheels and rear wheels. Patent Document 1 discloses an example of such a power transmission device. In the four-wheel drive vehicle described in Patent Document 1, the torque is transmitted from a first output shaft of the power transmission device to rear wheels through a rear propeller shaft, and from a second output shaft to front wheels through a front propeller shaft. However, it is known that, as a length of the propeller shaft is increased, a resonance frequency of the propeller shaft is reduced, thereby making the propeller shaft more likely to be resonated with a vehicle body and units of the vehicle body, and worsening vibration characteristics. As a countermeasure to this, Patent Document 2 discloses a technique for reducing a support span of the propeller shaft.

### PRIOR ART DOCUMENT

### Patent Document

[Patent Document 1] JP 2022-123683 A
[Patent Document 2] JP 2006-103500 A

### SUMMARY OF THE INVENTION

In the power transmission device for a four-wheel drive vehicle as described above, an outlet of the second output shaft in a casing of the power transmission device is located in a rear portion of the vehicle, so that a length of the front propeller shaft connected to the front wheels is increased. As a result, the resonance frequency of the front propeller shaft is reduced whereby the vibration characteristics are worsened and a maximum running speed of the vehicle could be reduced.

The present invention was made against the background of the above circumstances, and its purpose is to provide a power transmission device for a four-wheel drive vehicle, which is capable of reducing a length of a front propeller shaft and suppressing worsening of vibration characteristics and reduction of a maximum running speed of the vehicle.

According to the present invention, there is provided a power transmission device for a four-wheel drive vehicle that includes a power source. The power transmission device includes: (a) a first output shaft; (b) a second output shaft; (c) an input shaft configured to transmit a power of the power source; (d) a power distribution mechanism configured to distribute the power between the first output shaft and the second output shaft; (e) a rear propeller shaft connected to the first output shaft; (f) a front propeller shaft connected to the second output shaft; and (g) a casing that houses the input shaft, the first output shaft, the second output shaft and the power distribution mechanism. The input shaft, the first output shaft, the second output shaft, the rear propeller shaft and the front propeller shaft have axes that extend in a longitudinal direction of the vehicle. The casing includes front-side and rear-side walls that are opposite to each other in the longitudinal direction of the vehicle. The casing has an input opening which is provided in the front-side wall of the casing, such that the input shaft extends through the input opening. The casing has a first opening which is provided in the rear-side wall of the casing, such that the first output shaft extends through the first opening. The casing has a second opening which is provided in the front-side wall of the casing and which is other than the input opening, such that the second output shaft extends through the second opening. The power transmission device further comprises a transmission mechanism which is provided in a power transmission path between the power distribution mechanism and the second output shaft such that the power is to be transmitted through a power transmission position between the power distribution mechanism and the transmission mechanism. The transmission mechanism is disposed on an axis parallel to the axes, such that the transmission mechanism extends from the power transmission position toward a front side of the vehicle in the longitudinal direction of the vehicle.

In the power transmission device of the present invention, the power transmission path between the power distribution mechanism and the second output shaft is provided with the transmission mechanism which is disposed on the axis parallel to the above-described axes and which extends from the power transmission position toward the front side of the vehicle in the longitudinal direction of the vehicle. As a result, the second opening is provided in the front-side wall of the casing, which shortens the length of the front propeller shaft and suppresses worsening of frequency characteristics and reduction of maximum running speed value.

### BRIEF DESCRIPTION OF THE DRAWINGS

FIG. 1 is a view schematically showing a construction of a four-wheel drive vehicle to which the present invention is applied.

FIGS. 2A and 2B are views schematically showing a construction of a power transmission device shown in FIG. 1.

FIGS. 3A-3D are views schematically showing constructions of modifications of the power transmission device shown in FIGS. 2A and 2B.

FIG. 4 is a view schematically showing a construction of a power transmission device of another embodiment.

FIG. 5 is a view schematically showing a construction of a power transmission device of still another embodiment.

FIGS. 6A and 6B are views schematically showing constructions of power transmission devices of comparative examples.

### DETAILED DESCRIPTION OF PREFERRED EMBODIMENTS

Hereinafter, preferred embodiments of the present invention will be described in detail with reference to the drawings. It is noted that the drawings have been appropriately simplified or modified, and dimensional ratios and shapes of various parts are not necessarily drawn accurately.

### First Embodiment

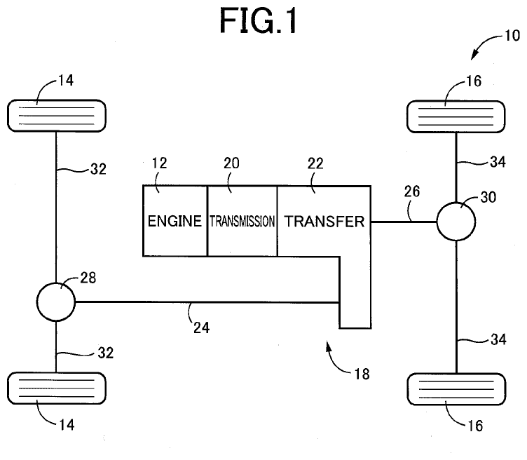

FIG. 1 is a view schematically showing a construction of a four-wheel drive vehicle (hereinafter simply referred to as “vehicle”) 10 to which the present invention is applied. The vehicle 10 includes an engine 12 as a power source, a transmission 20 connected to the engine 12, front wheels 14, rear wheels 16 and a power transmission device 18 configured to transmits a power (hereinafter referred to as “torque”) transmitted from the transmission 20 to the front wheels 14 and rear wheels 16. The vehicle 10 is a four-wheel drive (4WD) vehicle based on a front-engine rear-wheel drive (FR) system.

The power transmission device 18 includes a transfer 22, and a front propeller shaft 24 and a rear propeller shaft 26 that are connected to the transfer 22. To the front propeller shaft 24, a front differential gear device 28 and front drive shafts 32 are connected in this order. To the rear propeller shaft 26, a rear differential gear device 30 and rear drive shafts 34 are connected in this order. The transfer 22 distributes the torque of the engine 12 to the front wheels 14 and the rear wheels 16.

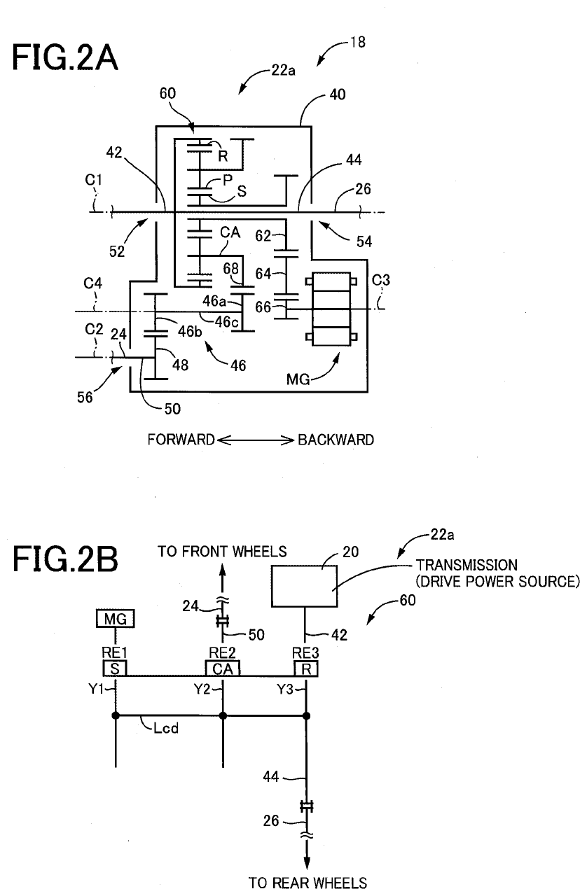

FIGS. 2A and 2B are views schematically showing a construction of the transfer 22 of the power transmission device 18 shown in FIG. 1. FIG. 2A shows the construction of the transfer 22a in the present embodiment, and FIG. 2B is a collinear diagram showing a relative relationship among rotational speeds of rotary elements of a differential mechanism 60 provided in the transfer 22a.

In FIG. 2A, the transfer 22a has a casing 40 that houses components. The transfer 22a includes an input shaft 42, a differential mechanism 60 and a first output shaft 44, which are arranged on a common axis C1 within casing 40. The transfer 22a further includes a transmission mechanism 46, a driven gear 48, a second output shaft 50 and an electric motor MG for torque distribution (described later). The electric motor MG is, for example, a so-called motor generator, and is a three-phase synchronous electric motor. An axis C2 is a rotation axis of the driven gear 48 and the second output shaft 50, and is parallel to the axis C1. The driven gear 48 and the second output shaft 50 are connected so as not to be rotatable relative to each other. An axis C3 is a rotation axis of the electric motor MG, and is parallel to the axis C1.

The casing 40 includes front-side and rear-side walls that are opposite to each other in a longitudinal direction of the vehicle 10. The casing 40 has an input opening 52 provided in the front-side wall of the casing 40, such that the input shaft 42 extends through the input opening 52. The casing 40 has a first opening 54 provided in the rear-side wall of the casing 40, such that the first output shaft 44 extends through the first opening 54. The casing 40 has a second opening 56 which is provided in the front-side wall of the casing 40 and which is other than the input opening 52, such that the second output shaft 50 extends through the second opening 56. The first output shaft 44 passes through the first opening 54 and is connected to the rear propeller shaft 26 so as not to be rotatable relative to the rear propeller shaft 26 about the axis C1. The second output shaft 50 passes through the second opening 56 and is connected to the front propeller shaft 24 so as not to be rotatable relative to the front propeller shaft 24 about the axis C2.

The differential mechanism 60 is a differential mechanism having three rotary elements consisting of a first rotary element RE1, a second rotary element RE2 and a third rotary element RE3. For example, the differential mechanism 60 is a known single-pinion type planetary gear device including a sun gear S, a carrier CA, a ring gear R and a plurality of pinions P supported by the carrier CA such that the sun gear S, the carrier CA and the ring gear R can be rotated and revolved. In the differential mechanism 60, the first rotary element RE1 corresponds to the sun gear S, the second rotary element RE2 corresponds to the carrier CA, and the third rotary element RE3 corresponds to the ring gear R. The sun gear S is connected through three MG connection gears 62, 64, 66 to the electric motor MG in a power transmittable manner. The carrier CA is connected through a front connection gear 68, the transmission mechanism 46 and the driven gear 48 to the second output shaft 50 in a power transmittable manner. The ring gear R is connected to the input shaft 42 and the first output shaft 44 so as not to be rotatable relative to the input shaft 42 and the first output shaft 44 about the axis C1.

FIG. 2B is a collinear diagram showing a relative relationship of rotational speeds of the rotary elements of the differential mechanism 60. In FIG. 2B, three vertical lines Y1, Y2,Y3 corresponding to the three rotary elements of the differential mechanism 60 that constitutes the transfer 22a are axes that, from left to right, represent the rotational speed of sun gear S corresponding to the first rotary element RE1, the rotational speed of the carrier CA corresponding to the second rotary element RE2, and the rotational speed of the ring gear R corresponding to the third rotary element RE3.

As shown in the collinear diagram of FIG. 2B, in differential mechanism 60, the first rotary element RE1 is connected to the electric motor MG in a power transmittable manner. The second rotary element RE2 is connected to the second output shaft 50 (front propeller shaft 24). Third rotary element RE3 is connected to the input shaft 42 and the first output shaft 44 (rear propeller shaft 26). In differential mechanism 60, line Lcd indicates the relationship among the rotational speeds of the first rotary element RE1, the second rotary element RE2 and the third rotary element RE3. The first output shaft 44 is an output shaft through which the power is to be outputted to the rear wheels 16, while the second output shaft 50 is an output shaft through which the power is to be outputted to the front wheels 14.

The differential mechanism 60 distributes the torque transmitted from the engine 12 (as the power source) through the transmission 20 and inputted to the third rotary element RE3, to the second rotary element RE2. The differential mechanism 60 corresponds to “power distribution mechanism” in the present invention. By operation of the differential mechanism 60, the torque is distributed torque between the front wheels 14 (second output shaft 50) and the rear wheels 16 (first output shaft 44) in the transfer 22a. The differential mechanism 60 distributes the torque between the front wheels 14 (second output shaft 50) and the rear wheels 16 (first output shaft 44) at any desired ratio according to a reaction torque by receiving the torque transmitted to the ring gear R at the sun gear S using the reaction torque of the electric motor MG. The reaction torque of the electric motor MG is controlled by, for example, an electronic control apparatus (not shown) that controls the vehicle 10. In the torque distribution, the electric motor MG is controlled to output a drive power. By controlling the reaction torque of the electric motor MG, the torque distribution ratio between the front wheels 14 (second output shaft 50) and the rear wheels 16 (first output shaft 44) can be changed as desired.

The transmission mechanism 46 is disposed on an axis C4 parallel to the axes C1 and C2, and includes a first transmission gear 46a that meshes with the front connection gear 68, a second transmission gear 46b that meshes with the driven gear 48, and a transmission shaft 46c that extends from the first transmission gear 46a toward a front side of the vehicle 10 in the longitudinal direction of the vehicle 10. The transmission shaft 46c is connected to the first transmission gear 46a and the second transmission gear 46b such that the first and second transmission gears 46a, 46b are not rotatable relative to each other about the axis C4. In other words, the transmission mechanism 46 extends from the first transmission gear 46a toward the front side of the vehicle 10 in the longitudinal direction of the vehicle 10. Since the carrier CA and the front connection gear 68 are connected so as not be rotatable relative to each other, the torque distributed to the carrier CA corresponding to the second rotary element RE2 is transmitted to the second output shaft 50 through the front connection gear 68, the transmission mechanism 46 and the driven gear 48. The axis C4 is parallel to the second output shaft 50 and the differential mechanism 60 as the power distribution mechanism, and corresponds to “axis parallel to the axes C1, C2” in the present invention. The first transmission gear 46a corresponds to “power transmission position through which the power is to be transmitted between the power distribution mechanism and the transmission mechanism” in the present invention.

In the transfer 22a, the torque is transmitted between the carrier CA and the second output shaft 50 through the transmission mechanism 46, so that the second opening 56 is provided in the front-side wall of the casing 40 and is located in the same position as the input opening 52 or located closer to the front side of the vehicle 10 than the input opening 52 in a direction of the axis C2, i.e., in an axial direction of the second output shaft 50. In FIG. 2A, the second opening 56 is located closer to the front side of the vehicle 10 than the input opening 52 in the direction of the axis C2. This shortens the length of the front propeller shaft 24.

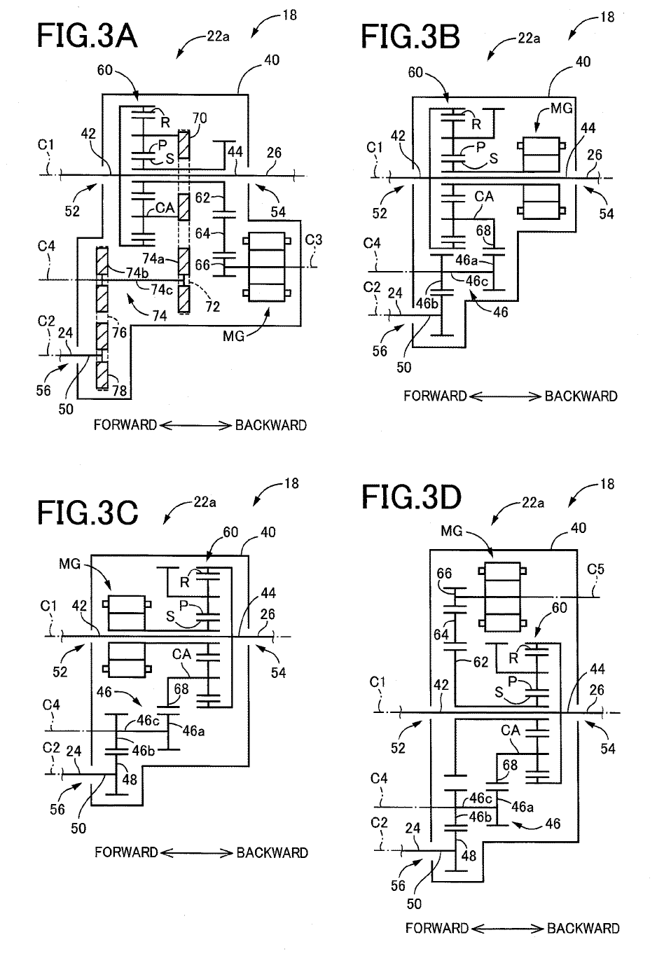

FIGS. 3A-3D are views schematically showing constructions of modifications of the transfer 22a shown in FIGS. 2A and 2B. The same parts as those in FIG. 2 are denoted by the same reference signs and their descriptions will be omitted.

FIG. 3A shows an example in which the torque transmission between the carrier CA corresponding to the second rotary element RE2 and the second output shaft 50 in the transfer 22a in FIG. 2A is changed from gear meshing to connection by chains. As shown in FIG. 3A, the torque distributed to the carrier CA is transmitted to the second output shaft 50 through a first sprocket 70 that is connected to the carrier CA so as not to be rotatable relative to the carrier CA about the axis C1, a chain 72, a transmission mechanism 74, a chain 76, and a fourth sprocket 78 that is connected to the second output shaft 50 so as not to be rotatable relative to the second output shaft 50 about the axis C2. The transmission mechanism 74 includes a second sprocket 74a connected to the chain 72, a third sprocket 74b connected to the chain 76, and a transmission shaft 74c which extends from the second sprocket 74a towards the front side of the vehicle 10 so as to connect between the second sprocket 74a and the third sprocket 74b such that the second sprocket 74a and the third sprocket 74b are not rotatable relative to each other about the axis C4. That is, the transmission mechanism 74 extends from the second sprocket 74a toward the front side of the vehicle 10. In this manner, a suitable method such as gear or chain connection may be selected for the connection within the transfer 22a. In FIG. 3A, too, the torque transmission between the carrier CA and the second output shaft 50 can be performed through the transmission mechanism 74, as in FIG. 2A, so that the second opening 56 can be located in the same position as the input opening 52 or closer to the front side of the vehicle 10 than the input opening 52 in the direction of axis C2. This shortens the length of the front propeller shaft 24. Similar to the first transmission gear 46a in the transmission mechanism 46, the second sprocket 74a corresponds to the “power transmission position through which the power is to be transmitted between the power distribution mechanism and the transmission mechanism” in the present invention.

FIGS. 3B, 3C and 3D show examples of modifications of the position of the electric motor MG in the transfer 22a shown in FIG. 2A. FIGS. 3B and 3C show examples where the electric motor MG is disposed on the axis C1, with FIG. 3B showing an example where the electric motor MG is located on a rear side of the differential mechanism 60 in the longitudinal direction of the vehicle 10, and FIG. 3C showing an example where the electric motor MG is located on a front of the differential mechanism 60 in the longitudinal direction of the vehicle 10. FIG. 3D shows an example where the electric motor MG is disposed on an axis C5. The axis C5 is parallel to the axis C1, and is located on one of opposite sides of the axis C1 which is remote from the axis C3. Where the electric motor MG is disposed on the axis C1 as in FIGS. 3B and 3C, a size of the transfer 22a in a width direction of the vehicle 10 can be reduced. Where the electric motor MG is disposed in an axis parallel to the axis C1 as in FIG. 3D and in FIG. 2A, a size of the transfer 22a in the longitudinal direction of the vehicle 10 can be reduced. A balance of the size of the transfer 22a in the width direction of the vehicle 10 can be changed depending on which one of the axes C3 and C5 the electric motor MG is disposed. Each of the axes C3 and C5 corresponds to the “axis that is parallel to the first output shaft” in the present invention. In this way, changing the location of electric motor MG changes the size of transfer 22a, making it possible to flexibly respond to layout requirements for vehicle 10. Further, by transmitting the torque between the carrier CA and the second output shaft 50 through the transmission mechanism 46, as in FIG. 2A, the second opening 56 can be located, for example, in the same position as the input opening 52 or located closer to the front side of the vehicle 10 than the input opening 52 in the direction of axis C2. This shortens the length of the front propeller shaft 24.

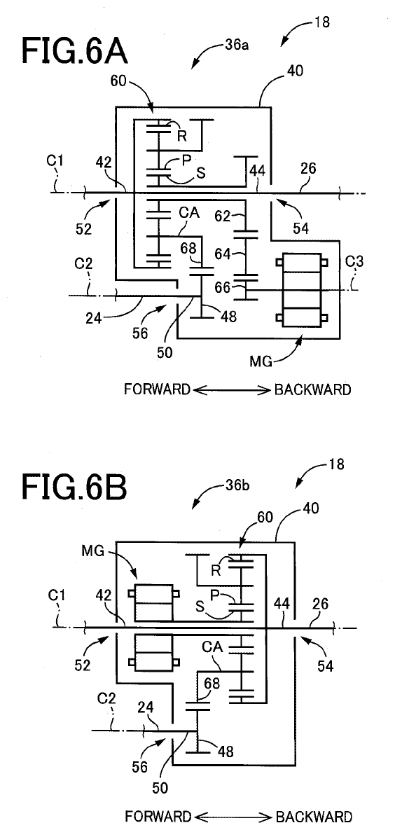

FIGS. 6A and 6B are views schematically showing constructions of power transmission devices of comparative examples. FIG. 6A shows a transfer 36a as the comparative example in which the transfer 22a of FIG. 2A has a conventional construction. FIG. 6B shows a transfer 36b as the comparative example in which the transfer 22a of FIG. 3C has a conventional construction. Both of the transfers 36a and 36b do not have the transmission mechanism 46, and the front connection gear 68 and the driven gear 48 are directly connected. Therefore, as shown in FIGS. 6A and 6B, the second opening 56 is located on a rear side of the input opening 52 in the longitudinal direction of the vehicle 10. As a result, in the comparative examples, the length of the front propeller shaft 24 is large, which may worsen the vibration characteristics and reduce the maximum running speed value. However, in the transfer 22a in the present embodiment (see FIGS. 2A and 3), the length of the front propeller shaft 24 is shortened, which reduces the vibration characteristics. The worsening of the vibration characteristic and the reduction of the maximum running speed value are suppressed.

As described above, according to this embodiment, the power transmission path between the differential mechanism 60 and the second output shaft 50 is provided with the transmission mechanism 46 (or transmission mechanism 74) which is disposed on the axis C4 parallel to the above-described axes axes C1 and C2 and which extends from the first transmission gear 46a (or second sprocket 74a) toward the front side of the vehicle 10 in the longitudinal direction of the vehicle 10. As a result, the second opening 56 is provided in the front-side wall of the casing 40, which shortens the length of the front propeller shaft 24 and suppresses worsening of frequency characteristics and reduction of maximum running speed value.

Further, according to the present embodiment, the second opening 56 is located in the same position as the input opening 52 or located closer to the front side of the vehicle 10 than the input opening 52 in the axial direction of the second output shaft 50. This provides the effect described in the previous paragraph.

Further, according to the present embodiment, the power transmission device 18 includes the electric motor MG, and the power distribution mechanism includes the three rotary elements consisting of the first rotary element RE1, the second rotary element RE2 and the third rotary element RE3. The electric motor MG is connected to the first rotary element RE1, the transmission mechanism 46 (or transmission mechanism 74) is connected to the second rotary element RE2, and the first output shaft 44 is connected to the third rotary element RE3. This makes it possible to arbitrarily change the torque distribution ratio between the front wheels 14 and the rear wheels 16.

Further, according to the present embodiment, the electric motor MG is disposed on the same axis C1 as the first output shaft 44 or disposed on the axis that is parallel to the first output shaft 44. This allows the size of the transfer 22a to be changed by changing the arrangement of the electric motor MG, thereby making it possible to flexibly respond to layout requirements for the vehicle 10.

Next, some other embodiments of the present invention will be described. In the following description, parts common to the above embodiment will be designated by the same reference numerals and description thereof will be omitted.

### Second Embodiment

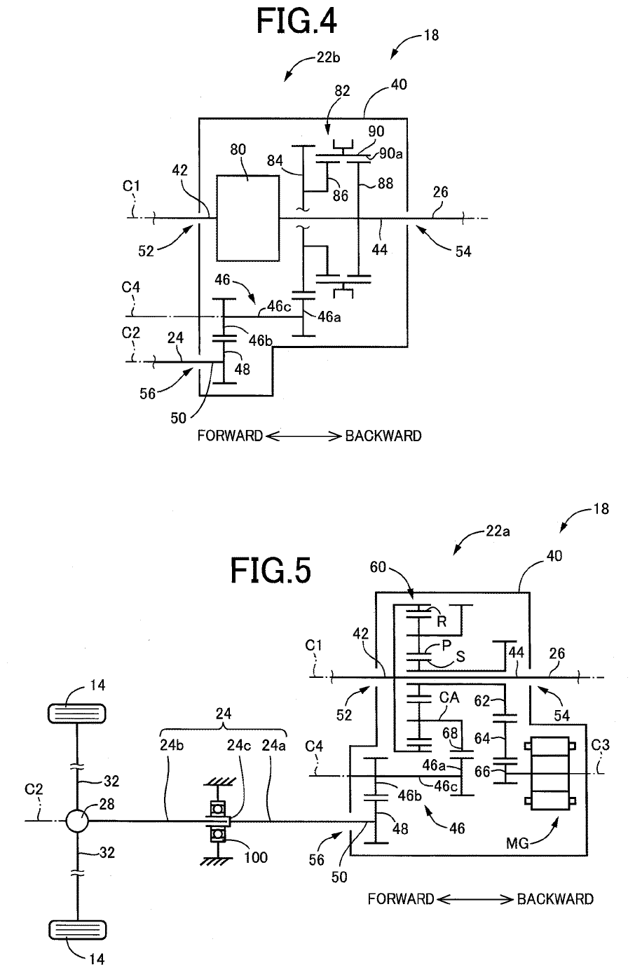

FIG. 4 is a view schematically showing a construction of a transfer 22b in the power transmission device 18 according to this second embodiment.

In FIG. 4, the transfer 22b includes the input shaft 42, an auxiliary transmission portion 80, a front connection/disconnection portion 82 and the first output shaft 44, which are disposed on the common axis C1 within the casing 40. The transfer 22b further includes the transmission mechanism 46, the driven gear 48 and the second output shaft 50 within the casing 40.

As in the above-described first embodiment, the casing 40 has the input opening 52, the first opening 54 and the second opening 56. The input shaft 42 passes through the input opening 52 and is connected to an input portion of the transmission 20. The first output shaft 44 passes through the first opening 54 and is connected to the rear propeller shaft 26 so as not to be rotatable relative to the rear propeller shaft 26 about the axis C1. The second output shaft 50 passes through the second opening 56 that is other than the input opening 52 and is connected to the front propeller shaft 24 so as not to be rotatable relative to the front propeller shaft 24 about the axis C2.

The auxiliary transmission portion 80 is an auxiliary transmission provided with a known planetary gear device and a meshing clutch, and transmits rotation of the input shaft 42 to the first output shaft 44 at a variable speed. The speed change is performed, for example, by the driver's operation and by the control of an electronic control apparatus that controls the vehicle 10. Alternatively, a second power source such as an electric motor, may be provided in place of the auxiliary transmission portion 80.

The front connection/disconnection portion 82 includes a front connection gear 84 that is rotatable relative to the first output shaft 44 about the axis C1, a lock gear 86 that is connected to the front connection gear 84 so as not to be rotatable relative to the front connection gear 84, a drive gear 88 that is not rotatable relative to the first output shaft 44 about the axis C1, and a connection/disconnection sleeve 90.

The front connection/disconnection portion 82 switches between connection and disconnection between the front connection gear 84 and the drive gear 88. The cylindrical connection/disconnection sleeve 90 has internal teeth 90a, and is provided so as not to be rotatable relative to the drive gear 88 about the axis C1. When the internal teeth 90a are engaged with the lock gear 86 with the cylindrical connection/disconnection sleeve 90 being moved in the direction of the axis C1, the front connection gear 84 and the drive gear 88 are engaged with each other so as to be rotatable integrally with each other.

The front connection gear 84 is connected to the driven gear 48 through the transmission mechanism 46 disposed on the axis C4, and the driven gear 48 is connected to the second output shaft 50 so as not to be rotatable relative to the second output shaft 50 about the axis C2. In other words, the front connection gear 84 and the second output shaft 50 (front propeller shaft 24) are connected to each other in a power transmittable manner.

In the released state of the front connection/disconnection portion 82, the power transmission path between the first output shaft 44 and the front connection gear 84 is interrupted and the torque transmitted from the engine 12 through the transmission 20 is transmitted only to the first output shaft (rear propeller shaft 26), namely, only to the rear wheels 16. In the engaged state of the front connection/disconnection portion 82 (as shown in FIG. 4), the torque is transmitted to the second output shaft 50 (front propeller shaft 24) and the first output shaft (rear propeller shaft 26), namely, to the front wheels 14 and the rear wheels 16. In other words, the front connection/disconnection portion 82 corresponds to “power distribution mechanism” in the present invention. The front connection/disconnection portion 82 is switched between the released state and the engaged state by, for example, control executed by the electronic control apparatus that controls the vehicle 10 based on the driver's operation.

In the transfer 22b in this second embodiment, by connecting the front connection gear 84 and the driven gear 48 through the transmission mechanism 46, so that the second opening 56 is provided in the front-side wall of the casing 40 and is located in the same position as the input opening 52 or located closer to the front side of the vehicle 10 than the input opening 52 in the direction of the axis C2. In FIG. 4, the second opening 56 is located in the same position as the input opening 52 in the direction of the axis C2. This shortens the length of the front propeller shaft 24.

As described above, according to this second embodiment, the power transmission path between the front connection/disconnection portion 82 and the second output shaft 50 is provided with the transmission mechanism 46 which is disposed on the axis C4 and which extends from the first transmission gear 46a toward the front side of the vehicle 10 in the longitudinal direction of the vehicle 10. As a result, the second opening 56 is provided in the front-side wall of the casing 40, which shortens the length of the front propeller shaft 24 and suppresses worsening of frequency characteristics and reduction of maximum running speed value.

Further, according to this second embodiment, the second opening 56 is located in the same position as the input opening 52 or located closer to the front side of the vehicle 10 than the input opening 52 in the direction of the axis C2. This provides the effect described in the previous paragraph.

### Third Embodiment

FIG. 5 is a view schematically showing a construction of the power transmission device of this third embodiment in which the front propeller shaft 24 is divided. The front propeller shaft 24 is divided, at an intermediate portion 24c located substantially in a center of the front propeller shaft 24 in the direction of the axis C2, into a first propeller shaft 24a connected to the second output shaft 50 of the transfer 22a and a second propeller shaft 24b connected to the front differential gear device 28. The first propeller shaft 24a and the second propeller shaft 24b are connected to each other at the intermediate portion 24c through, for example, a spline fitting, such that the first propeller shaft 24a and the second propeller shaft 24b are not rotatable relative to each other. The front propeller shaft 24 is rotatably supported at the intermediate portion 24c by a bearing 100 that is provided in the vehicle 10. With the front propeller shaft 24 being divided at the intermediate portion 24c and being rotatably supported at the intermediate portion 24 by the bearing 100 provided in the vehicle 10, each shaft member constituting the front propeller shaft 24 is shortened, and worsening of vibration characteristics and reduction of maximum running speed value are suppressed. The bearing 100 corresponds to the “support member” in the present invention. In this third embodiment, the transfer 22a may be replaced by the transfer 22b in the second embodiment.

As described above, according to this third embodiment, the front propeller shaft 24 includes the intermediate portion 24c that is located substantially in the center of the front propeller shaft 24 in the axial direction of the front propeller shaft 24, and is divided at the intermediate portion 24c. The front propeller shaft 24 is rotatably supported at the intermediate portion 24c by the support member 100 provided in the vehicle 10. This shortens the length of the front propeller shaft 24, thereby suppressing worsening of the vibration characteristic and reduction of the maximum running speed value.

Although the embodiments of the present invention have been described in detail above with reference to the drawings, the present invention can also be applied to other embodiments.

For example, in the above-described first to third embodiments, the vehicle 10 is a vehicle that uses the engine 12 as the power source, but the present invention can also be applied to a hybrid electric vehicle (HEV) that uses an engine and an electric motor as power sources, or a battery electric vehicle (BEV) that uses an electric motor as a power source.

Further, in the differential mechanism 60 in the first and third embodiments described above, the second rotary element RE2 may be either the carrier CA or the ring gear R, and the third rotary element RE3 may be the other of the carrier CA or the ring gear R. Where the second rotary element RE2 is the ring gear R and the third rotary element RE3 is the carrier CA, the second output shaft (front propeller shaft 24) is connected to the ring gear R, and the input shaft 42 and the first output shaft 44 (rear propeller shaft 26) are connected to the carrier CA. In this case, in the torque distribution between the front wheels 14 and the rear wheels 16, the electric motor MG is subjected to regenerative control.

It should be noted that the above is merely embodiments, and the present invention can be embodied in various forms with various modifications and improvements based on the knowledge of those skilled in the art.

### NOMENCLATURE OF ELEMENTS

10: vehicle (four-wheel drive vehicle)
12: engine (power source)
18: power transmission device
24: front propeller shaft
24c: intermediate portion
26: rear propeller shaft
40: casing
42: input shaft
44: first output shaft
46: transmission mechanism
46a: first transmission gear (power transmission position through which the power is to be transmitted between the power distribution mechanism and the transmission mechanism)
50: second output shaft
52: input opening
54: first opening
56: second opening
60: differential mechanism (power distribution mechanism)
74: transmission mechanism
74a: second sprocket (power transmission position through which the power is to be transmitted between the power distribution mechanism and the transmission mechanism)
82: front connection/disconnection portion (power distribution mechanism)
100: bearing (support member)
C1: axis (axis of first output shaft)
C2: axis (axis of second output shaft)
C3: axis (axis parallel to first output shaft)
C4: axis (axis parallel to axes)
C5: axis (axis parallel to first output shaft)
CA: carrier (second rotary element)
MG: electric motor
R: ring gear (second rotary element)
RE1: first rotary element
RE2: second rotary element
RE3: third rotary element
S: sun gear (first rotary element)

What is claimed is:

1. A power transmission device for a four-wheel drive vehicle that includes a power source,
the power transmission device comprising:
a first output shaft;
a second output shaft;
an input shaft configured to transmit a power of the power source;
a power distribution mechanism configured to distribute the power between the first output shaft and the second output shaft;
a rear propeller shaft connected to the first output shaft;
a front propeller shaft connected to the second output shaft; and
a casing that houses the input shaft, the first output shaft, the second output shaft and the power distribution mechanism,
wherein the input shaft, the first output shaft, the second output shaft, the rear propeller shaft and the front propeller shaft have axes that extend in a longitudinal direction of the vehicle,
wherein the casing includes front-side and rear-side walls that are opposite to each other in the longitudinal direction of the vehicle,
wherein the casing has an input opening which is provided in the front-side wall of the casing, such that the input shaft extends through the input opening,
wherein the casing has a first opening which is provided in the rear-side wall of the casing, such that the first output shaft extends through the first opening,
wherein the casing has a second opening which is provided in the front-side wall of the casing and which is other than the input opening, such that the second output shaft extends through the second opening,
wherein the power transmission device further comprises a transmission mechanism which is provided in a power transmission path between the power distribution mechanism and the second output shaft such that the power is to be transmitted through a power transmission position between the power distribution mechanism and the transmission mechanism, and
wherein the transmission mechanism is disposed on an axis parallel to the axes, such that the transmission mechanism extends from the power transmission position toward a front side of the vehicle in the longitudinal direction of the vehicle.

2. The power transmission device according to claim 1,
wherein the second opening is located in the same position as the input opening or located closer to the front side of the vehicle than the input opening in an axial direction of the second output shaft.

3. The power transmission device according to claim 1, further comprising an electric motor,
wherein the power distribution mechanism includes three rotary elements consisting of a first rotary element, a second rotary element and a third rotary element, and
wherein the electric motor is connected to the first rotary element, the transmission mechanism is connected to the second rotary element, and the first output shaft is connected to the third rotary element.

4. The power transmission device according to claim 3,
wherein the electric motor is disposed on the same axis as the first output shaft or disposed on an axis that is parallel to the first output shaft.

5. The power transmission device according to claim 1,
wherein the front propeller shaft includes an intermediate portion that is located substantially in a center of the front propeller shaft in an axial direction of the front propeller shaft, and is divided at the intermediate portion, and
wherein the front propeller shaft is rotatably supported at the intermediate portion by a support member provided in the vehicle.
